(19) United States
(12) Patent Application Publication
(10) Pub. No.: US 2023/0266163 A1
(43) Pub. Date: Aug. 24, 2023

(54) SUPERCONDUCTING NANOWIRE SINGLE PHOTON DETECTOR

(71) Applicant: TIANJIN UNIVERSITY, Tianjin (CN)

(72) Inventors: Xiaolong HU, Tianjin (CN); Yun MENG, Tianjin (CN); Kai ZOU, Tianjin (CN); Nan HU, Tianjin (CN); Liang XU, Tianjin (CN)

(21) Appl. No.: 17/264,844

(22) PCT Filed: Nov. 30, 2020
(86) PCT No.: PCT/CN2020/132752

§ 371 Date: Jan. 31, 2021

(30) Foreign Application Priority Data
Nov. 6, 2020 (CN) 202011233221.5

(51) Int. Cl. G01J 1/44

(52) U.S. Cl. CPC G01J 1/44; G01J 2001/442; B82Y 15/00

(57) ABSTRACT

The present invention discloses a superconducting nanowire single photon detector, comprises an arced fractal nanowire structure and the optical cavity structure; the arced fractal nanowire structures being used to alleviate the current-crowding effect and realize that the detection efficiency is insensitive to the polarization states of incident photons, and the arced fractal nanowire structures including parallel-connected arced fractal nanowires and serial-connected arced fractal nanowires; the optical cavity structure being used to achieve simultaneous optimization of the internal quantum efficiency and the absorption efficiency. The invention can be widely used in many fields such as optical communication, single-photon imaging, fluorescence detection, quantum optics, etc. The excellent performance of the detector can significantly promote the development and progress of these fields.

### CROSS-REFERENCE TO RELATED APPLICATIONS

This Application is a national stage application of PCT/CN2020/132752. This application claims priorities from PCT Application No. PCT/CN2020/132752, filed Nov. 30, 2020, and from the Chinese patent application 202011233221.5 filed Nov. 6, 2020, the content of which is incorporated herein in the entirety by reference.

### TECHNICAL FIELD

The present application relates to the technical field of optoelectronic devices, in particular to superconducting nanowire single photon detectors.

### BACKGROUND OF THE PRESENT INVENTION

Superconducting nanowire single photon detectors (hereinafter referred to as SNSPDs) have been developing rapidly in recent years, and their performances have been continuously pushed to new heights. Sae Woo Nam et al. at National Institute of Standards and Technology used molybdenum silicide superconducting materials to achieve 98% detection efficiency in the 1550 nm band in 2019 [Conference on Coherence and Quantum Optics, 2019, pp.W2B-2.]. In 2017, Val Zwiller et al. at Technische Universiteit Delft achieved 92% detection efficiency in the 1310 nm band using titanium niobium nitride superconducting materials [APL Photonics, 2017, 2(11): 111301.]. Lixing You et al. at Shanghai Institute of Microsystem and Information Technology Chinese Academy of Sciences used niobium nitride superconducting material to achieve 98% detection efficiency in the 1590 nm band [Optics Express, 2020, 28(24):36884.].

At present, all the reported SNSPDs with a detection efficiency over 60% adopted the meandering nanowire structures, but the meandering nanowire structures make the absorption efficiency of the SNSPD dependent on the polarization states of the incident light, that is, the absorption efficiency exhibits polarization sensitivity, which leads to that the overall detection efficiency is polarization sensitive. Prof. Xiaolong Hu's research group at Tianjin University in China used fractal nanowires to realize the polarization-insensitive SNSPD with 60% detection efficiency [Optics Letters, 2020, 45.2: 471-474.]. The research used the self-similarity of the fractal nanowires to almost eliminate the polarization sensitivity of the detection efficiency completely, and the polarization sensitivity is 1.05. Wherein, the ratio of the maximum detection efficiency over the minimum detection efficiency for all polarization states is defined as the polarization sensitivity.

Although the current crowding effect is reduced by reducing the fill factor of the fractal nanowire structures, thereby improving the internal quantum efficiency, the current crowding effect of the fractal nanowire structures is much more severe than that of the meandering nanowire structures under the same fill factor, making it more difficult for fractal SNSPDs to achieve saturated internal quantum efficiency and lower time jitter. In addition, the reported fractal SNSPDs all used Fabry-Perot optical cavity structures. Under the condition of low-fill-factor nanowires, the absorption efficiency of SNSPD is significantly reduced. The detection efficiency of SNSPD is the product of the coupling efficiency of the field of the incident light and the SNSPD photosensitive region, the absorption efficiency of the SNSPD photosensitive region for incident light, and the internal quantum efficiency of the SNSPD. And there are tradeoffs between the absorption efficiency and internal quantum efficiency of the fractal SNSPD integrated with the Fabry-Perot optical cavity. Accordingly, such tradeoffs limit the overall detection efficiency of fractal SNSPDs.

### SUMMARY OF THE PRESENT INVENTION

The present invention provides an arced fractal superconducting nanowire single-photon detector. The present invention reduces the current crowding effect by designing the topological structure of the SNSPD, improves the internal quantum efficiency, and realizes the polarization insensitivity of detection efficiency; on the other hand, the present invention designs an optical microcavity structure used to enhance the absorption efficiency of the nanowire in the targeted wavelength band, and finally realizes an arced fractal SNSPD with high detection efficiency and polarization insensitivity, as described below.

A superconducting nanowire single photon detector, comprises an arced fractal nanowire structure and the optical cavity structure.

The arced fractal nanowire structures are used to alleviate the current-crowding effect and realize that the detection efficiency is insensitive to the polarization states of incident photons, and the arced fractal nanowire structures includes parallel-connected arced fractal nanowires and serial-connected arced fractal nanowires.

The optical cavity structure is used to achieve simultaneous optimization of the internal quantum efficiency and the absorption efficiency.

Wherein, the parallel-connected arced fractal nanowires comprise:

A plurality of first level structures are sequentially rotated 90 degrees counterclockwise and then connected in series to obtain a second level structure; a pair of the second level structures are connected in parallel to obtain a third level structure; a plurality of third level structures are connected in series to form a two-dimensional plane as a photon detection area.

Further, the serial-connected arced fractal nanowires comprise: a plurality of the second level structures are sequentially rotated 90 degrees counterclockwise and then connected in series to form a photon detection area.

Preferably, the arced fractal nanowire structures are arced fractal nanowires with an optimized fill factor.

Wherein, the optical cavity structure is composed of two distributed Bragg reflectors arranged on the top and the bottom, and defect layers arranged in the middle.

The arced fractal nanowire is placed inside the defect layer, and the distributed Bragg reflectors are composed of a plurality of layers of dielectric materials with different refractive indices.

The beneficial effects of the technical solution provided by the present invention are:

1. The present invention realizes an arced fractal SNSPD with high detection efficiency and polarization insensitivity; it can be widely used in many fields such as optical communication, single-photon imaging, fluorescence detection, quantum optics, etc., the excellent performance of this detector can significantly promote development and progress in these applications;

2. the superconducting nanowires are designed to be the arced fractal nanowire structures to further reduce the current-crowding effect of the traditional fractal nanowire structure, and realize the detection efficiency and polarization insensitivity;

3. the present invention reduces the width of arced fractal nanowires to 40 nanometers to improve the internal quantum efficiency of SNSPD;

4. the present invention connects multiple arced fractal nanowires in parallel, which compensates the superconducting switching current of the ultranarrow nanowires and optimizes the timing characteristics of the ultranarrow nanowires; and

5. the present invention reduces the fill factor of the arced fractal nanowires to optimize the current-crowding effect, and designs the optical structure of the SNSPD to simultaneous optimize the internal quantum efficiency and the absorption efficiency.

### BRIEF DESCRIPTION OF THE DRAWINGS

FIG. 1 is a schematic diagram of the parallel arced fractal nanowire structure of the present invention;
wherein, FIG. 1(a) shows the first level structure; FIG. 1(b) shows the second level structure; FIG. 1(c) shows the third level structure; FIG. 1 (d) shows the whole photon detection area; FIGS. 1 (e)-1(g) show the series connection of the third level structures;

FIG. 2 is a schematic diagram of the circuit structure of the parallel-connected arced fractal nanowire shown in the FIG. 1;

FIG. 3 is a schematic diagram of the serial-connected arced fractal nanowire;

wherein, FIG. 3(a) shows the serial-connected arced fractal nanowire formed by connecting 4 second level structures in series; FIG. 3(b) shows the serial-connected arced fractal nanowire formed by connecting 9 second level structures in series;

FIG. 4 is the scanning-electron micrograph of the parallel-connected arced fractal nanowire, and the inset is the schematic diagram of the zoom-in micrograph of a unit;

FIG. 5 is a schematic diagram of the optical cavity structure with front illumination;

wherein, silicon dioxide (SiO2), tantalum pentoxide (Ta2O5), niobium titanium nitride (NbTiN), and silicon (Si) have been marked in FIG. 5; the same gray scale corresponds to the same material, and the horizontal dashed line is the boundary between a defect layer 1 and a defect layer 2.

FIG. 6 is a schematic diagram of the simulation results of the absorption efficiency of the arced fractal SNSPD varying with the total thickness of the defect layers for the two orthogonal polarization states of HE₁₁ₓ and HE_{11y};

FIG. 7 is a schematic diagram of the simulation results of the superconducting switching current suppression ratio (Isw/Ic) of the arced fractal SNSPD, the traditional Peano fractal SNSPD and the arced SNSPD and the absorption efficiency of the arced fractal SNSPD varying with the fill factor;

wherein, the superconducting switching current suppression ratio is defined as the ratio of the superconducting switching current (Isw) of the arced fractal nanowire of the same width to the superconducting switching current (Ic) of the straight nanowires;

FIG. 8 is a schematic diagram of a testing device for measure the detection efficiency;

FIG. 9 is a schematic diagram of the results of the maximum and minimum detection efficiency and polarization sensitivity of the arced fractal SNSPD as a function of the bias current;

FIG. 10 is a schematic diagram of a testing device used to measure timing jitter;

FIG. 11 is a schematic diagram of the results of the timing jitter of the arced fractal SNSPD as a function of the bias current.

### DETAILED DESCRIPTION OF THE PRESENT INVENTION

The present invention will be described in detail below with reference to the accompanying drawings by embodiments.

### Embodiment 1

A SNSPD, as shown in FIGS. 1-5, the embodiment of the present invention designs the SNSPD as an arced fractal nanowire structure to reduce the current-crowding effect, to improve the internal quantum efficiency, and to realize the detection efficiency and polarization insensitivity. On the other hand, by optimizing the fill factor of the arced fractal nanowires, the current-crowding effect is further reduced. Meanwhile, the optical structure of the arced fractal nanowires with the optimized fill factor is designed to simultaneously optimize the absorption efficiency and internal of the arced fractal SNSPD.

Specifically, the technical solution is composed of two parts: (1) the design and simulation of the arced fractal nanowire structure; (2) the design and simulation of the optical cavity structure.

(1) Design and Simulation of Arced Fractal Nanowire Structures

The arced fractal nanowires can be designed into parallel-connected arced fractal nanowires and serial-connected arced fractal nanowires.

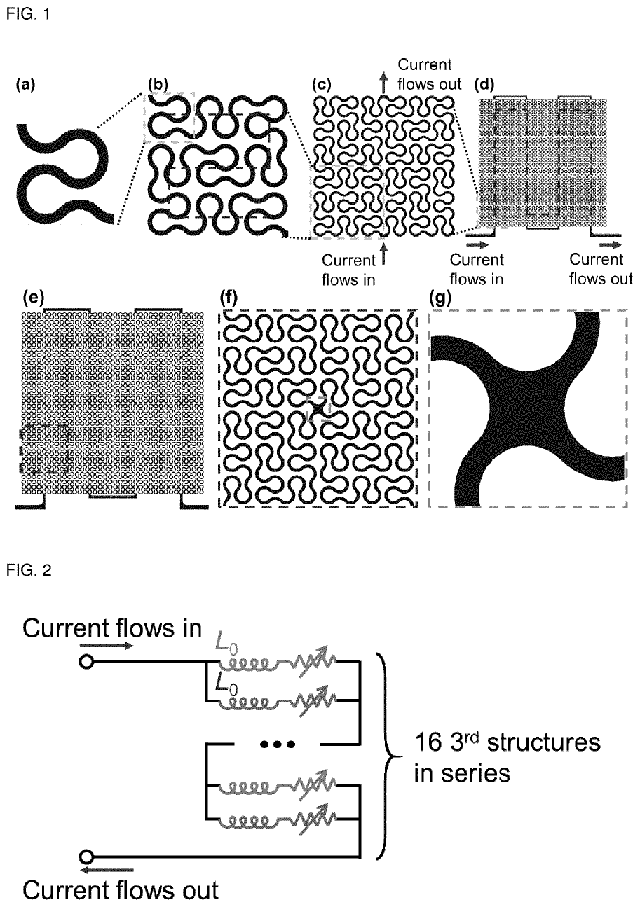

First, take the parallel-connected arced fractal nanowire as an example. The first level structure of the parallel-connected arced fractal nanowires is shown in FIG. 1(a); a plurality of the first level structures are sequentially rotated 90 degrees counterclockwise and then connected in series, taking 9 first level structures as an example, so as to obtain the second level structure as shown in FIG. 1(b); a pair of the second level structures are connected in parallel to obtain the third level structure as shown in FIG. 1(c); a plurality of the third level structures are connected in series to form an infinite two-dimensional plane as a photon detection area, taking 16 third level structures connected in series as an example, so as to form a photon detection area of 10.2 μm×10.2 μm, as shown in FIG. 1(d), arrows therein indicate current flow. The third level structures are connected in series as shown in FIGS. 1(e)-(g). FIG. 2 shows the circuit structure diagram of the parallel-connected arced fractal nanowire shown in FIG. 1(d).

The first level structure and the second level structure of the serial-connected arced fractal nanowires are the same structure as the first level structure and the second level structure of the parallel-connected arced fractal nanowires. The dashed frames in FIGS. 3(a), 3(b) identified the second level structure of the serial-connected arced fractal nanowire, and the arrows indicate the current flow. A plurality of the second level structures are sequentially rotated 90 degrees counterclockwise and then connected in series to form a photon detection area, taking 4 second level structures connected in series as an example, so as to form a photon detection area as shown in FIG. 3(a); or taking 9 second level structures connected in series as an example, thus forming a photon detection area as shown in FIG. 3(b).

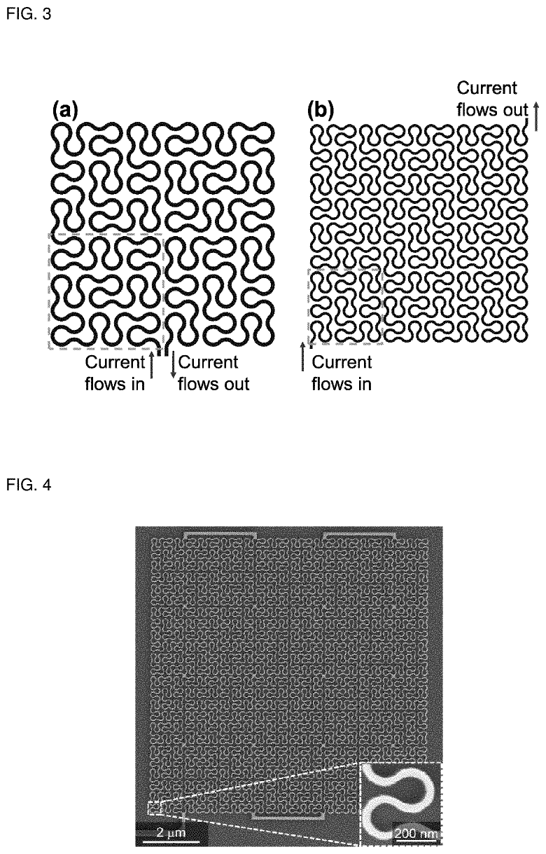

FIG. 4 shows a scanning-electron micrograph of a fabricated parallel-connected arced fractal nanowire.

It should be noted that this method is also applicable to other types of fractal structures (such as Hilbert-type fractal nanowires and Moore-type fractal nanowires), that is: a plurality of the first level structures are sequentially rotated 90 degrees counterclockwise and then connected in series to form a second level structure; a pair of the second level structures are connected in parallel to obtain a third level structure; a plurality of third level structures are connected in series to form a parallel-connected arced fractal nanowire; or a plurality of the second level structures are sequentially rotated 90 degrees counterclockwise and then connected in series to form a serial-connected arced fractal nanowire.

(2) Design and Simulation of Optical Cavity Structure

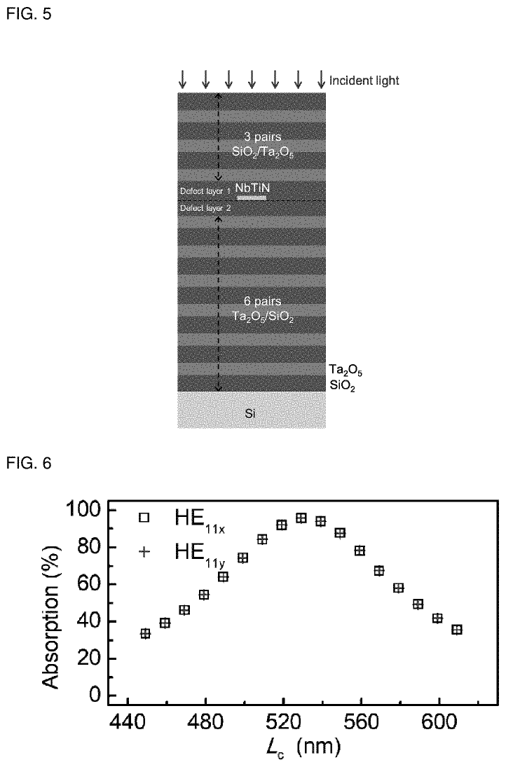

The optical structure of the arced fractal SNSPD is shown in FIG. 5. The optical microcavity is composed of two distributed Bragg reflectors arranged on the top and the bottom, and defect layers in the middle. The arced fractal SNSPD is placed inside the defect layers. The distributed Bragg reflector is composed of a plurality of layers of dielectric materials with different refractive indices, and the thickness of each layer of dielectric materials needs to meet the following formula:

$$d = \frac{λ}{4 n} \qquad ( 1 )$$

where λ is the wavelength of the incident light, and n is the refractive index of the dielectric material at the wavelength λ.

As shown in FIG. 5, taking a wavelength of 1550 nm as an example, the distributed Bragg reflector is composed of periodically arranged silicon dioxide and tantalum pentoxide, and the dielectric material of the defect layer is silicon dioxide. For other targeted wavelengths, this method also suitable for other dielectric materials, and the thickness of the dielectric layer needs to satisfy formula (1).

Wherein, the refractive indices of silicon dioxide and tantalum pentoxide at 1550 nm are 1.466 and 2.140, respectively. According to formula (1), the thickness of silicon dioxide and tantalum pentoxide that compose the distributed Bragg reflector are 264 nm and 181 nm, respectively. In the designing process, for the arced fractal SNSPD with different fill factors, the absorption efficiency of the arced fractal SNSPD at the targeted wavelength is optimized by adjusting the number of periods of the top and bottom distributed Bragg reflectors and the thickness of the defect layers. For the arced fractal nanowires with a fill factor of 0.31 and a width of 40 nm, the optimized structure is as follows: 6 pairs of the bi-layers forming the bottom distributed Bragg reflector, 3 pairs of the bi-layers forming the top distributed Bragg reflector, the total thickness of defect layer 1 and defect layer 2 is 529 nm, and the corresponding absorption efficiency is 96%. FIG. 5 shows the simulation results of the absorption efficiency of the arced fractal SNSPD with the total thickness of the defect layers under different polarization states. The nanowire width is 40 nm and the fill factor is 31%. The absorption efficiency of the arced fractal SNSPD shows polarization insensitiveness, and the absorption efficiency can reach 96%.

It should be noted that front illumination is not the only way of incidence. Back incidence can also be used to enhance the absorption efficiency of SNSPDs, but the number of periods of the corresponding distributed Bragg reflector and the total thickness of the defect layers need to be optimized. In addition, this technical solution is applicable to all currently commonly used superconducting materials for SNSPDs, such as niobium nitride, titanium niobium nitride, tungsten silicide, and molybdenum silicide.

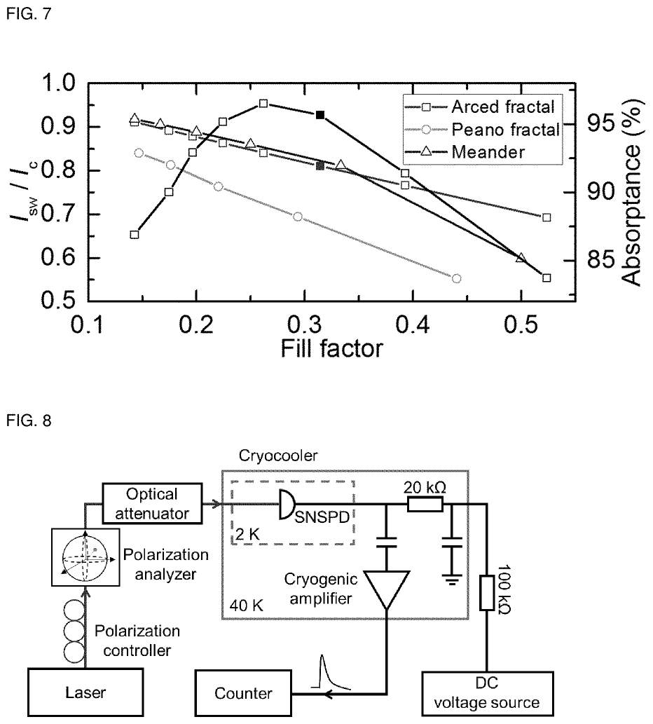

FIG. 7 shows the simulated results of the superconducting switching current suppression ratio of the arced fractal SNSPD, the traditional Peano fractal SNSPD and the arced SNSPD and the absorption efficiency of the arced fractal SNSPD varying with the fill factor. It can be seen from FIG. 7 that with the same fill factor, the current suppression ratio of the arced fractal SNSPD is close to that of the arced SNSPD, which is significantly higher than the current suppression ratio of the traditional Peano fractal SNSPD.

### Embodiment 2

The solution in Embodiment 1 will be further introduced below with specific examples. For details, see the following description:

1. Device Fabrication

Embodiment 2 took a front-illuminated DBR cavity and an arced fractal nanowire with the width of 40 nm as an example. First, 6 pairs of SiO₂/Ta2O5 layers with the thickness of 264 nm/181 nm were sequentially sputtered on a silicon substrate to realize the preparation of the bottom distributed Bragg reflector. The defect layer 2 was prepared by ion-beam-assisted deposition, and the material is SiO2. Then, a NbTiN film was prepared on the defect layer 2 by a reactive co-sputtering process, and then Au pads are prepared by the optical lithography and reactive sputtering or e-beam evaporation; followed by scanning-electron-beam lithography and reactive-ion etching in succession, the arced fractal nanowires were processed, as shown in FIG. 3. Then, ion-beam-assisted deposition was adopted again to fabricate the top defect layer 1, and 3 pairs of Ta₂O₅/SiO₂ layers with the thickness of 181 nm/264 nm as the top distributed Bragg reflector. Finally, the chip of the arced fractal SNSPD was etched by using silicon deep etching, to finish the fabrication process.

2. Device Testing

(1) Measurement of Detection Efficiency and Polarization Sensitivity

The test system is shown in FIG. 8. The tunable laser works as the source with a wavelength of 1550 nm. The process of the test system is as follows:

Connecting a polarization controller with the laser for adjusting the polarization states of the incident light;

Analyzing the polarization states by using a polarization analyzer and then the light passing through an optical attenuator for attenuation and then passing into a cryocooler; the light is then illuminating on the photon-detection area of the arced fractal SNSPD;

Biasing and reading out the pulses of the arced fractal SNSPD by using a bias T and cryogenic amplifier, and then registering output pulses by the counter to measure the system efficiency for different polarization states.

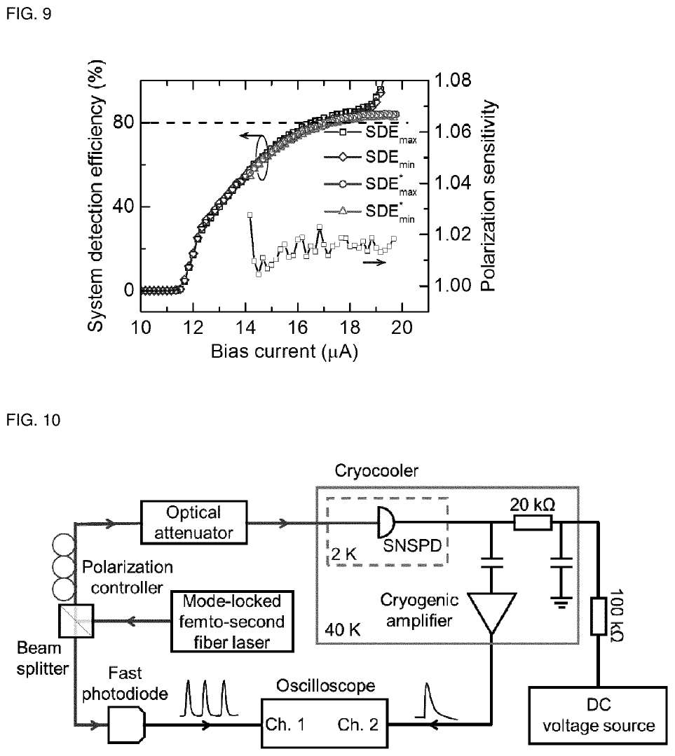

The embodiment of the present invention realizes the measurement of detection efficiency in different polarization states at 1550 nanometers through a front-illuminated test system. FIG. 9 shows the maximum detection efficiency (SDEmax) and minimum detection efficiency (SDEmin) of the arced fractal SNSPD at different bias currents. In order to verify the reliability of the detection efficiency, the time-correlated single-photon counting method proposed in the literature [S. Chen, L. You, W. Zhang, X. Yang, H. Li, L. Zhang, Z. Wang, and X. Xie, “Dark counts of superconducting nanowire single-photon detector under illumination,” Optics Express 23, 10786 (2015).] was used to re-measure the detection efficiency. The measured maximum detection efficiency (SDE*max), minimum detection efficiency (SDE*ₘᵢₙ), and polarization sensitivity (defined as SDE*ₘₐₓ/SDE*ₘᵢₙ), as functions of the bias current, are shown in FIG. 8. The results show that the maximum detection efficiency of the arced fractal SNSPD reaches 84%, and the corresponding polarization sensitivity is 1.02.

(2) Measurement of Timing Jitter

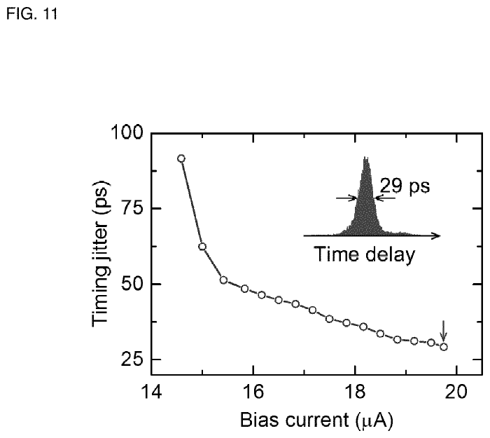

The test system is shown in FIG. 10. Light, emitted from the mode-locked femtosecond pulse laser with the central wavelength of 1560 nm, was passed through the beam splitter; one branch of the light was passed through the high-speed photodetector, and the electrical pulses generated by the high-speed photodetector was sent to the channel 1 of the oscilloscope; the other branch of light was sent to the arced fractal SNSPD after attenuation, and the electrical pulses generated by the arced fractal SNSPD are amplified by a cryogenic amplifier and then sent to the channel 2 of the oscilloscope. At different bias currents, using channel 2 of the oscilloscope as the trigger source, the oscilloscope registers the time differences corresponding to 50% of the maximum value of the pulse front edge of the two channels, and finally obtains histograms of the time differences. The full width at half maximum of the histograms was defined as the timing jitter of the arced fractal SNSPD. The test results are shown in FIG. 11. The inset in FIG. 10 shows the histogram of the pulse time difference between the two channels at the maximum bias current, and the full width at half maximum is 29 ps.

In the embodiment of the present invention, the model of each device is not limited except for special instructions, and the model of other devices is not limited, if the device can complete the above-mentioned functions.

Those skilled in the art can understand that the accompanying drawings are only schematic diagrams of a preferred embodiment, and the above-mentioned embodiments of the present invention are only for description, and do not represent the advantages and disadvantages of the embodiments.

The above descriptions are only preferred embodiments of the present invention and are not intended to limit the present invention. Any modification, equivalent replacement, improvement, etc. made within the spirit and principle of the present invention shall be included in the protection of the present invention.

What is claimed is:

1. A superconducting nanowire single photon detector, comprises an arced fractal nanowire structure and the optical cavity structure;
the arced fractal nanowire structures being used to alleviate the current-crowding effect and realize that the detection efficiency is insensitive to the polarization states of incident photons, and the arced fractal nanowire structures including parallel-connected arced fractal nanowires and serial-connected arced fractal nanowires; and
the optical cavity structure being used to achieve simultaneous optimization of the internal quantum efficiency and the absorption efficiency.

2. The superconducting nanowire single photon detector according to claim 1, wherein the parallel-connected arced fractal nanowires comprise:
a plurality of first level structures being sequentially rotated 90 degrees counterclockwise and then connected in series to obtain a second level structure; a pair of the second level structures being connected in parallel to obtain a third level structure; a plurality of third level structures being connected in series to form a two-dimensional plane as a photon detection area.

3. The superconducting nanowire single photon detector according to claim 1, wherein the serial-connected arced fractal nanowires comprise: a plurality of the second level structures being sequentially rotated 90 degrees counterclockwise and then connected in series to form a photon detection area.

4. The superconducting nanowire single photon detector according to claim 1, wherein the arced fractal nanowire structures are arced fractal nanowires with an optimized fill factor.

5. The superconducting nanowire single photon detector according to claim 1, wherein the optical cavity structure being composed of two distributed Bragg reflectors arranged on the top and the bottom, and defect layers arranged in the middle; and
the arced fractal nanowire being placed inside the defect layers, and the distributed Bragg reflectors being composed of a plurality of layers of dielectric materials with different refractive indices.
